(19) United States
(12) Patent Application Publication
(10) Pub. No.: US 2004/0038383 A1
(43) Pub. Date: Feb. 26, 2004

(54) Method for treating an organic gas

(76) Inventor: Masaya Iwamoto, Tokyo (JP)

Correspondence Address: VOLENTINE FRANCOS, PLLC, Suite 150, 12200 Sunrise Vally Drive, Reston, VA, 20191, US

(21) Appl. No.: 10/641,013

(22) Filed: Aug. 15, 2003

(30) Foreign Application Priority Data
Aug. 23, 2002 (JP) 242982/2002

(51) Int. Cl. C12S 5/00

(52) U.S. Cl. 435/266; 435/299.1; 435/289.1

(57) ABSTRACT

A method for treating an organic exhaust gas comprises the following steps. First, an organic exhaust gas containing a harmful substance is generated. Then, a treating liquid is provided. The organic exhaust gas is contacted with the treating liquid so as to dissolve the harmful substance into the treating liquid. Finally, bacteria are contacted with the treating gas containing the harmful substance so that the harmful substance is biochemically degraded.

### BACKGROUND OF THE INVENTION

This invention relates to a method for treating an organic exhaust gas from plants.

In a system for treating an exhaust gas from plants of semiconductor manufacturing, etc., the exhaust gas is treated under an optimum condition depending on its components, properties, states, etc. to make it harmless, which is then released in the air.

For instance, in a semiconductor plant, an organic exhaust gas, which has been generated when wafers are dried by means of a dryer after they are washed with an organic solvent such as isopropyl alcohol in the cleaning process or exhausted from developing and etching units in the photo-lithographic process, is conventionally cleaned by adsorbing organic contents in the gas to an adsorbent such as active carbon and then released in the air.

FIG. 3 is a schematic illustration of general organic exhaust gas treatment.

Organic chemical applying units 10, 11 and 12 arranged inside a plant are connected to an exhaust duct 16 through connecting pipelines 13, 14 and 15, respectively. The exhaust duct 16 pierces a wall 17 and is connected to an organic exhaust gas treating unit 19 through an exhaust fan 18 arranged outside.

An organic gas generated and remained in the organic chemical applying units 10, 11 and 12 is exhausted outside from the plant through the exhaust duct 16 under negative pressure caused by the exhaust fan 18 so that workers in a working area of the plant are not affected by such a gas.

The exhaust gas comprising a large quantity of organic gaseous content recovered from these units 10, 11 and 12 as described above is treated by means of the organic exhaust gas treating unit 19 to reduce a concentration of harmful content in the gas to a level of regulation and then released in the air from an exhaust vent 20.

There is generally employed a system of active carbon type as the organic exhaust gas treating unit 19 as shown in FIG. 3 because of the most effective absorption properties thereof. In an organic exhaust gas treating unit in which an active carbon fixed-bed is used to most effectively adsorb gaseous organic contents in the exhaust gas, organic substances are physically fixed to porous portions of active carbon on the surface. Since it is theoretically impossible to adsorb such organic substances any more beyond the adsorbability of fixed-bed, active carbon should be exchanged periodically, which makes the running cost quite high.

On the other hand, there has been recently used an organic exhaust gas treating unit in which already adsorbed gaseous organic contents are subjected to a desorption treatment. In the organic exhaust gas treating unit of desorption type, active carbon is still used as a adsorbing material similarly as conventional units. The desorption treatment is carried out periodically by treating the gaseous organic contents adsorbed on active carbon with heat or with steam to collect as organic liquid, which is disposed as an industrial waste.

Exchange of active carbon is not necessary basically in the above mentioned organic exhaust gas treating unit, however, much thermal energy should be consumed to desorb the absorbed gaseous organic contents and collect them. Here again, the running cost of this unit is also high similarly as the organic exhaust gas treating unit of fixed-bed type because of an increase in cost for treating the desorbed organic contents in liquid form as an industrial waste.

In contrast to these active carbon types, there is a wet treating system in which gaseous organic contents in an exhaust gas are dissolved in water through gas-liquid contact between the exhaust gas and water to treat them at a lower cost.

Packing materials such as Raschig Ring are used to increase an interfacial area of gas-liquid contact and improve contact efficiency between the gaseous organic contents and water. Treatment efficiency (concentration ratio of harmful materials after/before the treatment) of the wet system, however, is limited to about 80% in general, though depending on a treating condition thereof. Further, in certain circumstances, it is impossible to remove the gaseous organic contents to a desired extent depending on their concentration in an exhaust gas to be treated.

Furthermore, an additional waste water treating facilities is necessary to treat an organic sewage in which gaseous organic contents are dissolved. Accordingly, the organic exhaust gas can be treated by the wet treating system at a lower cost compared with the adsorption treatment by means of active carbon, while it is sometimes hard to thoroughly remove the gaseous organic contents contained in the organic exhaust gas. In addition, a facilities for treating waste water is necessary to decrease a concentration of harmful content in the organic sewage to a regulated level or less.

As has been described above, conventional treatments of organic exhaust gas might cause problems such as an increase in running cost, an environmental load to a considerable extent, etc.

### SUMMARY OF THE INVENTION

The present invention may provide a method and system for treating an organic exhaust gas at a lower cost with less environmental load compared with conventional ones.

According to this invention, there is provided a method for treating an organic exhaust gas comprises the following steps. First, an organic exhaust gas containing a harmful substance is generated. Then, a treating liquid is provided. The organic exhaust gas is contacted with the treating liquid so as to dissolve the harmful substance into the treating liquid. Finally, bacteria are contacted with the treating gas containing the harmful substance so that the harmful substance is biochemically degraded.

### BRIEF DESCRIPTION OF THE DRAWINGS

FIG. 1 is a structural view showing the process for treating an organic exhaust gas according to this invention.

FIG. 2 is a structural block diagram of the system for treating an organic exhaust gas according to this invention.

FIG. 3 is a schematic illustration of general organic exhaust gas treatment.

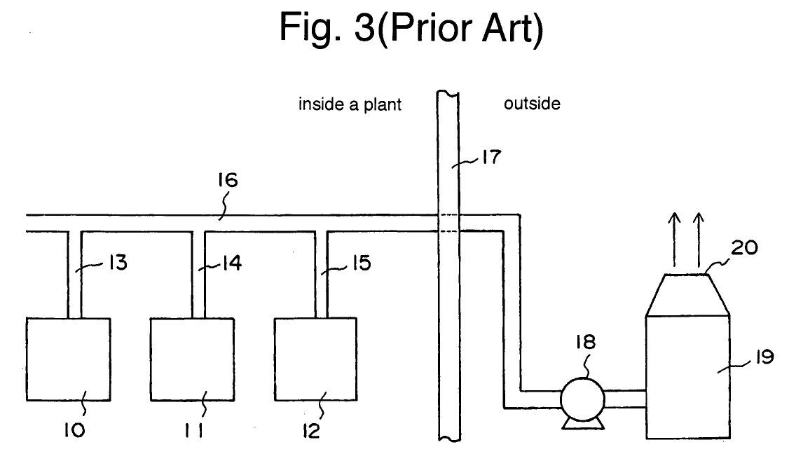

### DETAILED DESCRIPTION OF THE PREFERRED EMBODIMENTS

This invention will be described in turns from aspects of method for treating an organic exhaust gas, system for treating same and embodiments thereof as well as comparison with conventional technology.

[Method for Treating an Organic Exhaust Gas]

A method for treating an organic exhaust gas of this invention comprises at least a gas-liquid contact process for dissolving harmful organic substances in a treating liquid by bringing the harmful substance-containing organic exhaust gas into contact with the treating liquid and at least a biochemical degradation process for biochemically degrading the harmful materials, in which the biochemical degradation is carried out by bringing the organic exhaust gas-contacted treating liquid into contact with bacteria.

According to the method for treating an organic exhaust gas of this invention, harmful substances contained in the organic exhaust gas can be removed by bringing the organic exhaust gas into contact with treating liquid. The harmful substances are further subjected to a treatment of biochemical degradation by bringing the harmful substance-dissolved treating liquid into contact with bacteria to form harmless substances such as water and carbon dioxide.

There is employed a wet treatment system of gas-liquid contact by bringing the organic exhaust gas into contact with the treating liquid in this invention, which makes the running cost of treatment lower than that of conventional systems in which only active carbon is used to treat such an organic exhaust gas. The thus treated harmful substances dissolved in the treating liquid is then biochemically degraded by means of bacteria, which makes an environmental load thereof lesser.

An “organic exhaust gas” described in this invention means those gases which contain at least organic harmful substances for industrial use in plants, etc. as an organic gaseous content at a level above regulated concentration, while “harmful substances” mean those materials which might affect the environment at least to some extent when they are released in the air and are regulated by laws.

These harmful substances are not limited to specific materials but include volatile organic compounds especially used for producing semiconductors such as, for typical example, isopropyl alcohol (IPA) used in a wafer washing process followed by drying or an aqueous solution of tetramethylammonium hydroxide (TMAH) as a developer used for development during a lithography process.

“Treating liquid” used herein is not restricted to a specific kind of liquid so long as the liquid can dissolve the harmful substances and does not easily kill bacteria when both of them are brought into contact with each other. The treating liquid typically includes general industrial water, tap water or groundwater, and also river or lake water depending on its quality thereof.

It is preferable to use aquatic microbes, although there may be used any kind of bacteria at least capable of degrading the harmful substances. When the aquatic microbes are not used, the biochemical degradation of harmful substances might proceed insufficiently in certain cases because of difficulty in effective contact between the treating liquid containing harmful substances and the bacteria. These bacteria may degrade not only the harmful substances but any other compound dissolved in the liquid, respectively.

Both anaerobic and aerobic microbes may be used as the bacteria, although the latter is preferable.

The reason is that specific aerobic microbes are easily available with respect to various kinds of harmful substances when aerobic microbes are used as the bacteria capable of biochemical degradation of harmful substances.

There may be preferably used germs, algae, Protozoa, etc. as the useful bacteria of this invention, which can be adapted to various conditions including, for example, kinds and concentration of harmful substances to be treated as well as the treating liquid and, in addition, which can form an inherent biota and food chain according to the above mentioned conditions.

The most contributive bacteria above all to biochemical degradation of harmful substances are germs such as genus Zoogloea, genus Bacilus and genus Pseudomonas.

The biochemical degradation of harmful substances by means of aerobic microbes is preferably carried out at least in a gaseous oxygenic atmosphere. The harmful substances might be degraded insufficiently when the biochemical degradation thereof by means of aerobic bacteria is carried out in an atmosphere without oxygen gas.

Concentration of oxygen gas in an atmosphere of biochemical degradation may be adjusted depending on conditions such as genera of aerobic bacteria to be used as well as kinds and concentration of the harmful substances.

The harmful substances and other organic contents are biochemically degraded by means of bacteria into a harmless gaseous content and water which cause no problem when they are released in the air, although efficiency of treatment depends on kinds of substances to be thus degraded and a combination of bacteria. Components of degradation products comprise carbon dioxide and water for the most part when the bacteria are aerobes.

On the other hand, undissolved harmful substances might be present in the treating liquid at a level above regulated concentration after these substances are brought into contact with the liquid. It is preferable, in such a case, for the liquid-contacted organic exhaust gas to further bring into contact with active carbon so that the undissolved harmful substances are adsorbed to active carbon. A concentration of undissolved harmful substances in the treating liquid is decreased to a level below regulated concentration by subjecting the gas to an adsorption process as described above.

The bacteria-contacted treating liquid used in the method for treating an organic exhaust gas of this invention may be flown out of the system as it is, for example, to sewerage, river, lake, sea, etc., if the harmful substances dissolved in the treating liquid is biochemically degraded in full to a level below the regulated concentration.

In such a case, however, fresh treating liquid should be supplied again and again to the system for treating an organic exhaust gas, which makes it necessary to secure a water supply corresponding to an amount of treating water to be flown out. Further, a charged water source such as industrial water causes an increase in the running cost.

Accordingly, it is preferable in the method for treating an organic exhaust gas of this invention to recycle the treating liquid at least only within the gas treating system comprising a gas-liquid contact process and a biochemical degradation process, so that the bacteria-contacted treating liquid is repeatedly reused to bring it into contact with the organic exhaust gas again.

Referring now to the drawings, the method for treating an organic exhaust gas of this invention will be described with reference to drawings. It should be understood that this invention is not limited by the following construction.

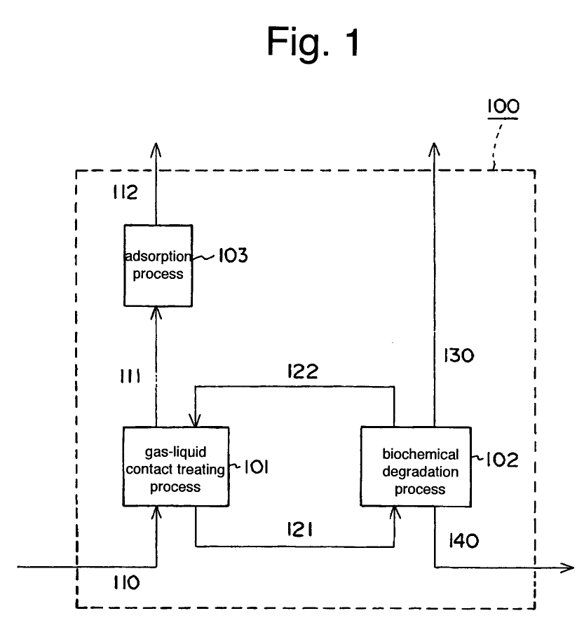

FIG. 1 is a block diagram of exemplary process for treating an organic exhaust gas according to this invention, wherein depicted by 100 is an organic exhaust system, 101 a gas-liquid contact process, 102 a biochemical degradation process and 103 adsorption process, 110, 111, 112 gas flow paths, 120, 121, 122, 123, 124 and 125 liquid flow paths, 130 gas flow path, 140 a sludge flow path. Depicted by Arrow signs 110 to 140 are flow directions of liquid, gas and sludge.

The system for treating organic exhaust gas 100 implies an area enclosed by a dotted line in FIG. 1 and comprises a gas-liquid contact treating process 101, biochemical degradation process 102, adsorption process 103, gas flow path 111 and liquid flow paths 121 and 122, as well as gas flow paths 110,112 and 130 and a sludge flow path 140 arranged within the dotted line.

The gas-liquid contact process 101 is connected to the gas flow paths 110 and 111 and the liquid flow path 122; the biochemical degradation process 102 is connected to the liquid flow paths 121 and 122, gas flow path 130 and sludge flow path 140; and the adsorption process is connected to the gas flow paths 111 and 112, respectively.

In the system for treating an organic exhaust gas 100, the organic exhaust gas is fed from an organic exhaust gas source outside of the system (not shown) to the gas-liquid process 101 through the gas flow path 110. On the other hand, treating liquid is circulated from the gas-liquid contact process 101 to the biochemical treatment process 102 through the liquid flow path 121, and also from the biochemical degradation process to the gas-liquid contact process 101 through the liquid flow path 122, so that the treating liquid is substantially not flown out of the system 100 except an irreducible flow-out due to evaporation, etc.

Further, the treating liquid is brought into contact with the organic exhaust gas in the gas-liquid contact process 101 and also with bacteria in the biochemical degradation process 102.

There will be described a treatment of organic exhaust gas in the above mentioned system for treating an organic exhaust gas 100 as in the following. The harmful substance-containing organic exhaust gas is supplied to the gas-liquid contact process 101 through the gas flow path 110 to bring it into contact with the treating liquid. The harmful substances contained in the organic exhaust gas are dissolved together with other organic contents during this process, thereby these substances being removed. A manner to bring the organic exhaust gas into contact with the treating liquid in the gas-liquid contact process 101 is not especially restricted but may be applied known methods of gas-liquid contact.

The organic exhaust gas is fed to the adsorption process 103 through the gas flow path 111 after the gas-liquid process 101 to remove residual harmful substances, which are hardly removed in the process 101 and still left in the exhaust gas, by a known adsorbing method. The organic exhaust gas in which the harmful substances have been removed to a level below regulated concentration is released outside of the system (in the air) as a harmless gas from the adsorption process 103 through the gas flow path 112.

On the other hand, the harmful substances and other organic contents contained in the organic exhaust gas are dissolved in the treating liquid during the gas-liquid contact process 101, which is then supplied to the biochemical degradation process 102 through the liquid flow path 121. The treating liquid which contains the harmful substances and other organic content is brought into contact with bacteria in the biochemical degradation process 102, thereby such substances and content being biochemically degraded to a harmless content such as water and carbon dioxide.

A gaseous content formed in the biochemical degradation process 102 (i.e. harmless gas such as carbon dioxide produced by a biochemical degradation of harmful substances) is released outside of the system (e.g., in the air) through the gas flow path 130. A solid component, mainly dead bacteria, is taken out of the system as sludge.

The treating liquid is thus treated in the biochemical degradation process 102 and then supplied to the gas-liquid contact process 101 through the liquid flow path 122 again to reuse for the treatment of gas-liquid contact thereof with the organic exhaust gas.

[System for Treating an Organic Exhaust Gas]

A system for treating an organic exhaust gas applying the gas treating method of this invention will be described in the following.

According to this invention, there is provided a system for treating an organic exhaust gas comprising at least a gas-liquid contact means for bringing a harmful substance-containing organic exhaust gas into contact with treating liquid to dissolve the harmful substances in the treating liquid and at least an organic substance degradation means for biochemically degrading the harmful substances, in which at least the gas-liquid contact means and the organic substance degradation means are connected so that the exhaust gas-contacted treating liquid is transferred from the gas-liquid contact means to the organic substance degradation means, while the organic substance degradation means provided with bacteria, which are arranged to bring into contact with the organic exhaust gas-contacted treating liquid, so that the biochemical degradation is carried out by bringing at least the exhaust gas-contacted treating liquid into contact with the bacteria.

The system for treating an organic exhaust gas of this invention is not limited by a specific construction, if the system is constructed at least as described above. However, in order to remove the harmful substances in an organic exhaust gas until it reaches to a level below regulated concentration at a low running cost thereof and further to carry out the biochemical degradation treatment of harmful substances dissolved in the treating liquid more effectively, it is preferable to have a construction as will be described in the following.

The organic substance degradation means preferably comprises at least carriers which are arranged to bring them into contact with the organic exhaust gas-contacted treating liquid, aquatic microbes as the bacteria being supported on the carrier.

When the aquatic microbes are neither used nor supported on the carrier to be brought into contact with the treating liquid, effective contact of such microbes and the treating liquid is hardly done, which sometimes causes insufficient biochemical degradation of harmful substances or a decrease in an efficiency of biochemical degradation.

There is no specific restriction with regard to the carriers, if effective fixation, i.e., maintenance or multiplication, of bacteria can be done, although there may be used known carriers such as a biological filter medium.

On the other hand, the harmful substances are not removed sufficiently and occasionally left at a level above the regulated concentration in the organic exhaust gas after contact thereof with the treating liquid.

In such a case, the system for treating an organic exhaust gas of this invention preferably comprises at least an adsorption means provided with active carbon, in which the gas-liquid contact means and the adsorption means are connected so that the organic exhaust gas after contact thereof with the treating liquid is transferred from the gas-liquid contact means to the adsorption means, followed by bringing the organic exhaust gas after contact thereof with the treating liquid contact with active carbon to adsorb the harmful substances thereto.

For that reason, it is possible to remove the harmful substances in the organic exhaust gas after contact thereof with the treating liquid to an extent below the regulated level and then to release in the air as a harmless gas. There is no restriction with regard to a shape of active carbon, although honeycomb structure is preferable from a standpoint of adsorptivity.

The treating liquid used in the system for treating an organic exhaust gas of this invention may be flown out of the system as it is, for example, to sewerage, river, lake, sea, etc., if the harmful substances dissolved in the treating liquid is biochemically degraded in full to a level below the regulated concentration.

It is necessary, however, to secure a water supply in this case as has been described above, which might sometimes cause an increase in the running cost.

Accordingly, the system for treating an organic exhaust gas of this invention preferably have a structure in which the gas-liquid contact means and the organic substance degradation means are connected so that the treating liquid after contact thereof with bacteria is transferred from the organic substance decomposition means and is circulated only within the system for treating an organic exhaust gas comprising at least the gas-liquid contact means and the biochemical degradation means.

As the treating liquid is circulated only within the system for treating an organic exhaust gas, occurrence of problems as mentioned above can be avoided. The treating liquid is lost little by little from the system due to evaporation, etc., and thus may be supplied, if necessary. Further, the treating liquid circulated in the system may also be replaced, if necessary, when the organic exhaust gas treating system is maintained.

[Embodiments of the System for Treating an Organic Exhaust Gas]

Referring to the drawings, an embodiment of the system for treating an organic exhaust gas of this invention will be described in the following. It should be noted as a matter of course that the system of this invention is not limited only by a structure shown in the drawings.

Structure of the System for Treating an Organic Exhaust Gas

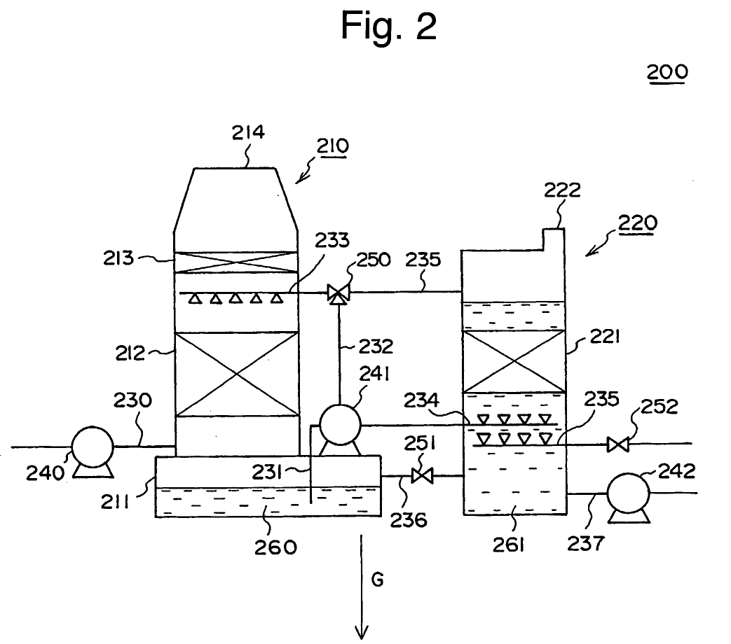

FIG. 2 is a structural block diagram of the system for treating an organic exhaust gas of this invention.

In FIG. 2, depicted by 200 is a system for treating an organic exhaust gas, 210 exhaust gas absorption tower, 211 treating liquid tank, 212 packing section (gas-liquid contact means), 213 honeycomb structure of active carbon (adsorption means), 214 exhaust vent, 220 an organic substance degradation tower, 221 biological filter medium (biochemical degradation means), and 222 and exhaust vent, 230 to 232 pipelines, 233 sprinkling pipe, 234 up-flow washing nozzle, 235 air diffusing pipe, 236 and 237 pipelines, 240 an exhaust fan, 241 pump (treating liquid circulation pump), 242 pump (sludge draw-out pump), 250 a valve (three-way valve), 251 and 252 valve (two-way valve), 260 and 261 treating liquid. Depicted by An arrow G is a direction of gravity, which is hereinafter referred to as downside, downward or bottom, and the opposite direction as upside, upward or top.

The system for treating an organic exhaust gas 200 comprises the exhaust gas absorption tower 210 and the organic substance degradation tower 220 provided with pipelines 230, 231, 232, 236 and 237 connected thereto, sprinkling pipe 233, up-flow washing nozzle 234, air diffusing pipe 235, exhaust fan 240, pumps 241 and 242 and valves 250, 251 and 252.

The exhaust gas absorption tower 210 is provided with the treating liquid tank 211 in the bottom and the packing section 212 upward of the tank 211. The honeycomb structure of active carbon 213 is arranged upward of the packing section 212, while the exhaust vent 214 is arranged on the top of the exhaust gas absorption tower 210.

One end of pipeline 230 is connected to a side surface of the exhaust gas absorption tower 210 between the treating liquid tank 211 and the filer material section 212. Further, the other end of pipeline 230 is connected to the exhaust fan 240 which is in connection with an organic exhaust gas source (not shown) such as organic chemical applying facilities inside a plant.

The treating liquid 260 is stored in the treating liquid tank 211 at least under an ordinary operational condition of the system for treating an organic exhaust gas 200. The treating liquid tank 211 communicates with the pump 241 through the pipeline 231, while one end of the pipeline 231 is arranged in the upper vicinity of the bottom of the tank 211 so as to keep it below a level of the treating liquid 260.

The pump 241 is connected to a pipeline portion of the up-flow nozzle 234 and the pipeline 232 to pump up the treating liquid through the pipeline 231 and feed the treating liquid to the pipeline 232 and/or the up-flow nozzle 234.

The three-way valve 250 is connected to the pipeline 232, a pipeline portion of the sprinkling pipe 233 and the pipeline 235. The treating liquid may be supplied from the pipeline 232 to both of the sprinkling pipe 233 and the pipeline 235 through the valve 250 by controlling the liquid flow by means of the valve 250.

Sprinkle nozzle portions of the sprinkle pipe 233 are arranged downwardly between the packing section 212 and the honeycomb structure of active carbon 213 in the exhaust gas absorption tower 210. The treating liquid supplied to the sprinkling pipe 233 through a route as mentioned above is sprinkled from the nozzle portions of the sprinkling pipe 233 throughout the filer material section 212.

The filer material section 212 is filled with a packing material such as Raschig Ring so that gas-liquid contact is conducted effectively between the harmful substance-containing organic exhaust gas which passes through the packing section 212 upward and the treating liquid which flows downward through the section 212.

The treating liquid flowed downward from the packing section 212 is stored in the treating liquid tank 211 located downward of the section 212, while the organic exhaust gas passed through the section 212 upward further passes the honeycomb structure of active carbon 213 and then released in the air from the exhaust vent 214.

There may be periodically analyzed whether a concentration of harmful substances in the gaseous content released from exhaust vent 214 is below a level of regulation or not, and when a deterioration of active carbon 213 in ability to adsorb the harmful substances is detected as a result thereof, the honeycomb structure of active carbon 213 is exchanged. The frequency of exchange is twice a year or so in general even when the system for treating an organic exhaust gas 200 is operated substantially all the year round except a period of shut-down due to maintenance, etc.

The biological filter medium 221 which supports aquatic microbes is arranged near to an intermediate portion of the exhaust gas absorption tower 220 in the gravitational direction, while nozzle portions of the up-flow washing nozzles 234 and then those portions of the sprinkling nozzles 235 are arranged downward in order so that they are faced close to downside of the biological filter medium 221. Both of these nozzles are arranged to turn upward.

The pipeline 235 is connected to a side surface of the organic gas absorption tower 221 above the biological filter medium 221 so that the treating liquid 260 stored in the treating liquid tank 211 is supplied to the biological filter medium 221 from upside. The treating liquid 261 is stored in the organic gas absorption tower 220 at a level enough to soak the biological filter medium 221 partially or thoroughly at least when the system for treating an organic exhaust gas 200 is operated.

A pipeline portion of the sprinkling pipe 235 is connected to the valve 252 arranged outside of the organic substance degradation tower 220, while the valve 252 is connected to a compressed air source (not shown). A desired volume of air (oxygen-containing air) is fed to the sprinkling pipe 235 by handling the valve 252, thereby finely bubbled air being supplied throughout the biological filter medium 221 from the nozzle portions of sprinkling pipe 235.

So, when aerobic microbes are used as bacteria, the finely bubbled air is supplied to these microbes supported on the biological filter medium 221.

The up-flow washing nozzle 234 makes it possible to inject the treating liquid upward from nozzle portions thereof from the bottom of the biological filter medium 221. When permeability of air, which is fed from the sprinkling pipe 235 and passed through the biological filter medium 221 upward, is decreased because of a large number of dead bacteria adhered on the surface of the medium 221, it is possible to remove such adhered dead bacteria by injecting the treating liquid from the nozzle portions of the up-flow washing nozzles 234.

Accordingly, when aerobic microbes are used as bacteria, air is supplied to the aerobic microbes by means of the sprinkling pipe 235 and, at the same time, air-permeability of the biological filter medium 221 can be secured by means of the up-flow washing nozzles 234. For that reason, stable growth and multiplication of these aerobic microbes are obtainable, while ability to treat harmful substances and other organic contents by biochemical degradation can be kept constantly.

On the other hand, one end of the pipeline 236 is connected to a side surface portion of the organic substance degradation tower 220 in the vicinity of the bottom thereof to circulate the treating liquid 261 to the treating liquid tank 211 after the liquid 261 is supplied from the pipeline 235 and passed through the biological filter medium 221 from upside to downside. The other end of the pipeline 236 is connected to the treating liquid tank 211 and provided with the valve 251 in the middle thereof.

A level of the treating liquid 261 stored in the organic substance degradation tower 220 is kept sufficiently high compared with the treating liquid tank 211 under an ordinary operating condition of the system for treating an organic exhaust gas 200, which causes difference in water pressure to transfer the treating liquid 261 from the organic substance degradation tower 220 to treating liquid tank 211 through the pipeline 236. The treating liquid 261 stored in the organic substance degradation tower 220 is thus supplied to the treating liquid tank 211 owing to the difference in water pressure, while an amount of the liquid 261 to be supplied can be controlled by means of the valve 251.

Sludge (not shown) is deposited on the bottom of the organic substance degradation tower 220 because of dead bacteria which have been adhered on the biological filter medium 221 and washed off by means of the up-flow valves 234 as described above. In order to remove the sludge from the organic substance degradation tower 220, the pipeline 237 is connected to a side surface portion of the tower 220 in the vicinity of the bottom below a level of the pipeline 236 which is also connected thereto. The pump 242 is connected to the pipeline 237 and is in connection with a sludge storage (not shown). The sludge deposited on the bottom of the organic substance degradation tower 220 can be thus removed therefrom outside.

There causes a gaseous content such as carbon dioxide as a result of biochemical degradation of harmful substances and other organic contents contained in the treating liquid 261 by means of bacteria supported on the biological filter medium 221. The above mentioned gas component and air fed from nozzle portions of the sprinkling pipe 235 are released in the air from the exhaust vent 222 arranged on the top of the organic degradation tower 220.

Treatment of an Organic Exhaust Gas Using the System for Treating the Gas

A treating process of an organic exhaust gas using the system for treating an organic exhaust gas 200 of the above mentioned structure will be detailed in the following.

An organic exhaust gas which contains harmful substances and other organic contents is fed from the pipeline 230 to the exhaust adsorption tower 210 through the exhaust fan 240. The thus fed organic exhaust gas flows upward through the packing section 212, thereby being subjected to gas-liquid contact with the treating liquid sprinkled by means of nozzle portions of the sprinkling pipe 233 to dissolve the harmful substances and other organic contents in the liquid.

The organic exhaust gas passed through the packing section 212 further goes up to the honeycomb structure of active carbon 213 to bring into contact with active carbon during its passage therethrough so that remaining harmful substances which are not absorbed in the treating liquid is adsorbed to active carbon to a level below the regulated concentration. The organic exhaust gas passed through the honeycomb structure of active carbon 213, in which the harmful substances are removed to a level below the regulated concentration, is then released in the air as a harmless gas from the exhaust vent 214.

On the other hand, the treating liquid passed through the packing section 212 is stored in the treating liquid tank 211 and supplied to the three-way valve 250 again through the pipeline 231, pump 241 and pipeline 232. The treating liquid thus supplied to the three-way valve 250 is partially supplied to the sprinkling pipe 233 to reuse for gas-liquid contact in the packing section 212 by further sprinkling from nozzle portions of the sprinkling pipe 133 (such a repeatedly circulating route of the treating liquid in the exhaust gas absorption tower 210 through the pipeline 231, pump 241, pipeline 232, three-way valve 250 and sprinkling pipe 233 will hereinafter be referred to as “route A”).

A remainder of the treating liquid which is not supplied to the three-way valve 250 through the pipeline 232 is supplied to the organic substance degradation tower 220 through the pipeline 235. The treating liquid supplied to the organic substance degradation tower 220 passes through the biological filter medium 221 from upside to downside. At that time, the treating liquid brings into contact with bacteria supported on the biological filter medium 221 to form a harmless gas like carbon dioxide and water by biochemical degradation of the harmful substances and other organic contents in the liquid. The treating liquid after passing through the biological filter medium 221 is supplied to the treating liquid tank 211 again through the pipeline 236 (such a repeatedly circulating route of the treating liquid in the organic substance degradation tower 220 through the pipeline 236, treating liquid tank 211, pipeline 231 pump 241, pipeline 232, three-way valve 250 and pipeline 236 will hereinafter be referred to as “route B”).

An amount of the treating liquid to be supplied to the treating liquid tank 211 through the pipeline 236 is controlled by means of the valve 251 as well as an amount supplied to the organic substance degradation tower 220 through the pipeline 235 is controlled by means of the valve 251 to maintain a level of the treating liquid enough to soak the biological filter medium 221.

An amount of the treating liquid circulating in the route A (hereinafter referred to as “circulating amount A” and an amount thereof circulating in the route B (hereinafter referred to as “circulating amount B” are controlled by handling the three-way valve 250. When aerobic microbes are used as bacteria, the circulating amounts A and B are controlled to keep a concentration of organic substances such as harmful ones contained in the treating liquid circulating in the route B, or Biological Oxygen Demand (hereinafter referred to as “BOD”) at a level below 200 mg/L as a tentative standard. The reason is that washing of the biological filter medium 221 by means of the up-flow washing nozzles 234 or removal of sludge through the pipeline 237 is frequently required due to considerable occurrence of dead bacteria on the medium 221.

BOD of the treating liquid circulating the route A is preferably controlled to around 150 mg/L, although it depends on a concentration of the harmful substances and other organic contents contained in the organic exhaust gas and a thickening rate of the treating liquid.

[Comparison with Conventional Technology]

There will be described a running cost and treating efficiency in the system for treating an organic exhaust gas as shown in FIG. 2 compared with conventional systems.

1) Comparison with a System of Active Carbon Fixed-Bed Type for Treating an Organic Exhaust Gas

In order to compare each running cost per day (Japanese Yen Y/day) when an organic exhaust gas is treated by means of the system for treating an organic gas 200 and a conventional system of active carbon fixed-bed type, both systems were compared according to the following procedure on the basis of actually estimative assumption and approximation.

First of all, an amount of the harmful substance to be treated (X) was determined according to the following formula (1) on the assumption as will be described below:

X=Q×60×Hr1×[273/(273+t)]×(MW1×22.4)×C×1/10⁶ (1)

wherein X is an amount of the harmful substance to be treated (kg/day), Q is a volume of an organic exhaust gas (m³/min), Hr1 is a period of time to operate an exhaust fan per day (hr/day), t is temperature of an organic exhaust gas (° C.), MW1 is molecular weight of the harmful substance and C is a concentration of organic content other than the harmful substance contained in an organic exhaust gas.

A concentrations of organic content other than the harmful substance contained in the organic exhaust gas were regarded as low as negligible.

As a result, the amount of harmful substance (isopropyl alcohol; IPA) (X) is calculated at 7.2 kg/day according to the formula (1) on the following assumption:

volume of an organic exhaust gas Q=200 m³/min;

period of operating time per day Hr1=24 hr/day;

temperature of the organic exhaust gas t=20° C.;

molecular weight of the harmful substance (IPA) MW1=60 g (IPA is regarded as the harmful substance in this case); and

concentration of the organic substance contained in the organic exhaust gas C=100 ppm.

Calculation of a Running Cost in a Conventional System for Treating an Organic Exhaust Gas

There is calculated a running cost spent to treat the harmful substance (IPA) in an amount of 7.2 kg/day determined in the conventional system for treating an organic exhaust gas.

The running cost is calculated on the assumption that the system for treating an organic exhaust gas is a type in which the organic exhaust gas is treated by means of an active carbon fixed-bed and has sufficient ability to treat the harmful substance of 7.2 kg/day. Since there is no substantial difference in an operating cost of the exhaust fan between the conventional system and that of this invention, the running cost is calculated except for the operating cost of the exhaust fan.

The running cost is represented by the formula (2) as follows:

Y=Y1+Y2 (2)

wherein Y is a running cost per day of the system for treating an organic exhaust gas of active carbon fixed-bed type (¥/day), Y1 is a cost for exchanging active carbon per day (¥/day) and Y2 is a thermal disposal cost of exchanged active carbon (¥/day).

The running cost Y is also represented by the following formula (3) applying an amount of active carbon exchanged or consumed a day, a unit price of fresh active carbon per weight and a thermal disposal cost per weight of exchanged active carbon:

Y=VC'(@NC+@EC) (3)

wherein Y is a running cost per day of the system for treating an organic exhaust gas of active carbon fixed-bed type (¥/day) VC is an amount of active carbon exchanged or consumed a day (kg/day), @NC is a unit price of fresh active carbon per weight (¥/kg) and @EC is a thermal disposal cost per weight of exchanged active carbon (¥/day).

An amount of active carbon exchanged a day (VC) is represented by the following formula (4) applying an amount of the harmful substance (IPA) to be treated and equilibrium adsorption of the harmful substance (IPA) to active carbon:

VC=X/(0.8×EA) (4)

wherein VC is an amount of active carbon exchanged or consumed a day (kg/day), X is an amount of the harmful substance (IPA) to be treated (kg/day) and EA is equilibrium adsorption of the harmful substance (IPA) to active carbon (%).

A value expressed by “0.8×EA” represents effective adsorption of the harmful substance (IPA) to active carbon (%).

A running cost per day of the system for treating an organic exhaust gas of active carbon fixed-bed type is calculated at Y=¥75,000/day or so according to the formulas (3) and (4) on the following assumption:

equilibrium adsorption of the harmful substance (IPA) to active carbon EA=6.6%;

unit price of fresh active carbon per weight @NC=¥500/kg; and

thermal disposal cost per weight of exchanged active carbon @EC=¥55/day.

Calculation of a Running Cost in a System for Treating an Organic Exhaust Gas of this Invention

There is calculated a running cost spent to treat the harmful substance (IPA) in an amount of 7.2 kg/day determined in the system for treating an organic exhaust gas of this invention.

The running cost was calculated on the assumption that the system for treating an organic exhaust gas is similarly structured as the system 200 as shown in FIG. 2 and has sufficient ability to treat the harmful substance in an amount of 7.2 kg/day. IPA-degrading aerobic microbes such as genus Zoogoea were used as bacteria to biochemically degrade IPA. The running cost is calculated except for the operating cost for a reason as described above.

A running cost of the system for treating an organic exhaust gas 200 is represented by the following formula (5) on the above mentioned assumption:

Z=Z1+Z2+Z3 (5)

wherein Z is a running cost per day (¥/day) of the system for treating an organic exhaust gas 200, Z1 is a cost of compressed air per day (¥/day), Z2 is a power cost for operating the pump 241 per day (¥/day) and Z3 is a sludge disposal cost per day (¥/day).

There are some expenses other than the three kinds of cost as described above, such as a cost for exchanging the honeycomb structure of active carbon 213 or for replacing it twice a year or so, but such a cost is regarded as substantially low as negligible compared with these three. For that reason, the running cost is calculated applying the three costs only in the formula (5).

First of all, a cost of compressed air per day Z1 in the formula (5) is calculated according to the following formula (6):

Z1=@AIR×VA/DA (6)

wherein @AIR is a unit price per unit volume of compressed air (converted volume into air under a condition of 1 atm (101.3 kPa) at 0° C.) (¥/m³), VA is an air consumption per day (kg/day) and air density under a condition of 1 atm (101.3 kPa) at 0° C.) (¥/m³).

Complete biochemical degradation of the harmful substance (IPA: C₃H₇OH) by means of bacteria is represented by the following chemical formula (7):

2C₃H₇OH+18O₂→6O₂+8H₂O (7)

It is understood from the formula (7) that at least 9 mol of oxygen is stoichiometrically necessary to biochemically degrade 1 mol of the harmful substance (IPA) to perfection.

A theoretically required amount oxygen per day (VO) is determined according to the following formula (8):

VO=[(X×1000)/MW1]×TO×(MW2/1000) (8)

wherein VO is a theoretically required amount of oxygen (kg/day), X is an amount of the harmful substance (IPA) to be treated per day (kg/day), MW1 is molecular weight of the harmful substance (IPA), TO is a ratio of oxygen required to biochemically degrade 1 mol of the harmful substance (IPA) to perfection, i.e., oxygen/harmful substance (IPA) in mol (mol/mol) and MW2 is molecular weight of oxygen (g).

An amount of the harmful substance (IPA) to be treated (X) is 7.2 kg/day and molecular weight of the harmful substance (IPA) (MW1) is 60 g as described above, while oxygen/harmful substance (IPA) is 9 mol/mol as described with regard to the formula (7) and molecular weight of oxygen (MW2) is 32 g. Accordingly, a theoretically required amount of oxygen per day is calculated at VO=34.56 kg/day from the formula (8).

Air consumption per day (VA) is represented by the following formula (9):

VA=CT×VO/0.2 (9)

wherein VA is air consumption per day (kg/day), CT is constant and VO is a theoretically required amount of oxygen (kg/day).

The constant CT is a numeral value to reflect the fact that oxygen should be supplied in an amount more than what is theoretically required because of presence of oxygen which does not contribute to the reaction. The CT is a value of about 1.5, although it depends on various factors such as construction and condition to degrade organic substances, etc. A numeral value “0.2” in the formula (9) means a partial ratio of oxygen contained in the air. Thus, air consumption per day is calculated at VA=259.2 kg/day on the assumption: the constant CT=1.5.

Further, a cost of compressed air per day (Z1) is calculated at Z1=¥1,000/day on the following assumption:

density of air under condition of 1 atm (101.3 kPa) at 0° C. (DA) is 1.3 kg/m³ and a unit price per unit volume of compressed air (converted volume into air under a condition of 1 atm (101.3 kPa) at 0° C.) (@AIR) is ¥5/m³.

A power cost for operating the pump 241 per day (Z2) of the formula (5) can be found according to the following formula (10):

Z2=@E×PW×Hr2 (10)

wherein Z2 is a power cost for operating the pump 241 per day (¥/day), @E is a unit power cost per KW·H (¥/KWH), PW is power output of the pump 241 (KW) and Hr2 is an operating time of the pump 241 (hr).

Power output of the pump 241 is determined by pumping ability thereof per unit hour. The sum of an amount of the treating liquid circulated in the route A and that of the liquid in the route B per unit hour, i.e., the pumping ability required to the pump 241, is found in a manner as will be described in the following, from which the power out put is then obtained.

An amount of the treating liquid circulating in the route A per hour is calculated at 1,000 L/min on the following assumption:

the packing section 212 in the exhaust gas absorption tower is 3.4 m² in sectional area and 2 m in height, a packing material packed therein is Raschig Ring and the liquid/gas ratio is 10L/m³, i.e., a similar value in general packed towers. Such an amount of the liquid can be found on the basis of general knowledge of chemical engineering, although a detailed process of calculation is omitted herein.

An amount of the treating liquid circulating in the route B per unit hour is calculated at 0.03 L/min on the assumption that BOD of the treating liquid flowed into the organic substance degradation tower 220 through the pipeline 235 is about 150 mg/L, which is found by dividing an amount of the harmful substance (IPA) (X=7.2 kg/day) by the value of BOD (150 mg/L).

Since the minimum pumping ability required to the pump 241 is about 1,000 L/min, it is necessary for the pump 241 to have a pumping ability of about 1,100 L/min while considering the margin of pumping ability. Power output of the pump 241 is regarded as PO=5.5 KW, because reasonable power output corresponding to such ability is about 5.5 KW. Finally, a power cost for operating the pump 241 per day is calculated at Z2=¥1,584/day from the formula (10) by further assuming that a unit power cost (@E) is ¥12/KWH and operating hour of the pump 241 (Hr2) is 24 hr. A sludge disposal cost per day (Z3) of the formula (5) can be found according to the following formula (11):

Z3=MUW×@MU (11)

wherein Z3 is a sludge disposal cost per day (¥/day), MUW is weight of sludge (in a not-dehydrated condition) per day (kg/day) and @MU is a sludge disposal cost (in a not-dehydrated condition) per unit weight (¥/kg).

Since sludge caused by dead bacteria comprises the solid content and water, the sludge disposal cost is calculated according to the formula (11) by assuming that the sludge in question is treated in a not-dehydrated condition.

Weight of sludge in a not-hydrated condition per day (MUW) is calculated at 1,440 kg/day (as a result of calculation: MUW=an amount of the harmful substance to be treated (X)×2/0.01) on the assumption that an amount of solid content in the sludge is double weight of organic substances like the harmful substance dissolved in the treating liquid, although it varies depending on conditions such as specific species of bacteria or bait to be fed, and a concentration of solid content contained in the sludge is about 1% by weight.

Further, a sludge disposal cost per day (Z3) is calculated from the formula (11) at ¥28,800/day on the assumption: sludge disposal cost (in a not-dehydrated condition) per unit weight (@MU)=¥20/kg.

Comparison of Running Cost

On the basis what has been described above, a running cost (Z) of the system for treating an organic exhaust gas 200 per day is calculated at about ¥32,000/day according to the formula (5). This result is about half of similar running cost in the case of the conventional system of active carbon fixed-bed type (Y=about ¥75,000/day), which shows that a cost for treating an organic exhaust gas can be greatly decreased by this invention.

Comparison of Treating Efficiency

Since an organic exhaust gas is passed through the honeycomb structure of active carbon 213 in the system for treating an organic exhaust gas 200 in advance and then released in the air, it is possible to remove the harmful substance (IPA) which is insufficiently eliminated in the packing section 212. That is to say, such a manner that the harmful substance is adsorbed to and removed by active carbon before the organic exhaust gas is released in the air is the same as the conventional system for treating an organic exhaust gas of active carbon fixed-bed type, thereby treating efficiency of similar level being obtained.

2) Comparison with a Wet Type System for Treating an Organic Exhaust Gas

Treating Efficiency

Treating efficiency in a conventional wet type system for treating an organic exhaust gas is 80% or so. On the other hand, according to the system for treating an organic exhaust gas 200, the harmful substance, which is insufficiently eliminated by gas-liquid contact, can be removed mostly by passing through the honeycomb structure of active carbon 213 in the packing section 212. Treating efficiency of 100% may be obtained by such a combination of the gas-liquid contact treatment (wet treatment) and the adsorption treatment.

Effective Use of Water Resources and Environmental Loads

According to a conventional wet type system for treating an organic exhaust gas, water for gas-liquid contact treatment is always exchanged to fresh one before concentrations of harmful substances and other organic contents contained in the water rise to a certain level while considering to keep the treating efficiency or treating ability of waste water treating facilities. In other words, as the water for gas-liquid treatment can not be reused repeatedly, a certain quantity of fresh water should be always supplied to the conventional system.

Further, the water used for gas-liquid treatment is transferred to a waste water plant to treat it by means of a waste water treatment facilities where a concentration of harmful substances is reduced to a regulated level. For instance, considerable thermal energy should be consumed when the water used for gas-liquid contact treatment is concentrated and then subjected to combusting oxidative decomposition or other treatments to decompose or detoxify harmful substances. On the other hand, further thermal energy is also required to exchange or regenerate active carbon when the harmful substances are detoxified through physical adsorption by means of active carbon. These conventional systems cause a secondary but additional cost other than the running cost with regard to the system for treating an organic exhaust gas itself, or increase environmental loads.

According to a system for treating an organic exhaust gas of this invention such as the system 200, however, water or treating liquid used for gas-liquid contact treatment is circulated repeatedly, which almost neglects to always supply a certain quantity of water except what is lost by evaporation during a maintenance service or in general operation, and makes it possible to use water resources effectively.

Further, since harmful substances contained in the water (treating liquid) used for gas-liquid contact treatment are treated by means of bacteria in the exhaust gas treating system, it is not necessary to apply considerable thermal or other kind of energy. Accordingly, environmental loads are quite low, even from a total viewpoint throughout a series of processes for treating an organic exhaust gas. This fact is similarly demonstrated when the present system is compared with those conventional systems of active carbon type.

What is claimed is:

1. A method for treating an organic exhaust gas comprising:
generating an organic exhaust gas containing a harmful substance;
providing a treating liquid;
contacting the organic exhaust gas with the treating liquid so as to dissolve the harmful substance into the treating liquid; and
contacting bacteria with the treating gas containing the harmful substance so that the harmful substance is biochemically degraded.

2. A method for treating an organic exhaust gas according to claim 1, wherein the bacteria are aquatic microbes.

3. A method for treating an organic exhaust gas according to claim 1, wherein the bacteria are selected from a group consisting of genus Zoogloea, genus Bacilus and genus Pseudomonas.

4. A method for treating an organic exhaust gas according to claim 1, further comprising contacting the liquid-contacted organic exhaust gas with an active carbon so as to adsorb the harmful substance to the active carbon.

5. A method for treating an organic exhaust gas according to claim 1, wherein the treating liquid is circulated only in a system for treating an organic exhaust gas comprising at least the gas-liquid contact process and the biochemical degradation process.

6. A system for treating an organic exhaust gas comprising:
a gas-liquid contact unit bringing an organic exhaust gas containing a harmful substance into contact with a treating liquid so as to dissolve the harmful substance into the treating liquid; and
an organic substance degradation unit connected to the gas-liquid contact unit, the organic substance degradation unit biochemically degrading the harmful substance,
wherein the exhaust gas-contacted treating liquid is transferred from the gas-liquid contact unit to the organic substance degradation unit, and
wherein the organic substance degradation unit provides with bacteria, which are arranged to bring into contact with the organic exhaust gas-contacted treating liquid, so that the biochemical degradation is carried out by bringing at least the exhaust gas-contacted treating liquid into contact with the bacteria.

7. A system for treating an organic exhaust gas according to claim 6, wherein the organic substance degradation unit includes a carrier arranged to bring thereof into contact with the organic exhaust gas-contacted treating liquid, and wherein aquatic microbes as the bacteria are supported on the carrier.

8. A system for treating an organic exhaust gas according to claim 6, further comprising an adsorption unit including an active carbon, wherein the gas-liquid contact unit and the adsorption unit are connected to each other so that the treating liquid contacted organic exhaust gas is transferred from the gas-liquid contact unit to the adsorption unit to bring the treating liquid-contacted organic exhaust gas into contact with the active carbon so as to adsorb the harmful substance to the active carbon.

9. A system for treating an organic exhaust gas according to claim 6, wherein the gas-liquid contact unit and the biochemical degradation unit are connected to each other so that the bacteria-contacted treating liquid is transferred from the organic substance degradation unit to the gas-liquid contact unit, and wherein the treating liquid is circulated only in a system for treating an organic exhaust gas including the gas-liquid contact unit and the biochemical degradation unit.
